(19) United States
(12) Patent Application Publication
(10) Pub. No.: US 2025/0289140 A1
(43) Pub. Date: Sep. 18, 2025

(54) Systems, Computer Program Products, and Methods for Controlling Robots Through a Graphical User Interface

(71) Applicant: Sanctuary Cognitive Systems Corporation, Vancouver (CA)

(72) Inventor: Suzanne Gildert, Vancouver (CA)

(21) Appl. No.: 18/991,646

(22) Filed: Dec. 22, 2024

Related U.S. Application Data
(60) Provisional application No. 63/614,488, filed on Dec. 22, 2023.

(51) Int. Cl. B25J 13/06; B25J 9/16

(52) U.S. Cl. CPC B25J 13/06; B25J 9/1694

(57) ABSTRACT

Control systems for controlling operation of a robot, as well as computer program products and methods thereof are provided herein, The control system comprises a robot, including a plurality of sensors configured to convert information from the environment and the robot into sensor data and a plurality of actuators; a cognitive architecture control system, communicatively coupled to the robot, configured to control the robot, to receive the sensor data, to generate a robot-egocentric model of the environment from the sensor data, and to output autonomous actuator data to the plurality of actuators of the robot, based on at least one instruction; and a graphical user interface configured to display a graphical representation of the robot-egocentric model to a human operator and enable the human operator to select the at least one instruction from a pre-determined instruction set, based on the robot-egocentric model, to control the robot semi-autonomously.

### TECHNICAL FIELD

The present systems, computer program products, and methods generally relate to controlling operation of said systems and computer program products, and particularly relate to multi-purpose robots that are capable of at least semi-autonomously completing multiple different work objectives.

### DESCRIPTION OF THE RELATED ART

Robots are machines that may be deployed to perform work. Robots may come in a variety of different form factors, including humanoid form factors. Humanoid robots may be operated by teleoperation systems through which the robot is caused to emulate the physical actions of a human operator or pilot; however, such teleoperation systems typically require very elaborate and complicated interfaces comprising sophisticated sensors and equipment worn by or otherwise directed towards the pilot, thus requiring that the pilot devote their full attention to the teleoperation of the robot and limiting the overall accessibility of the technology.

Robots may be trained or otherwise programmed to operate fully autonomously. Training a robot typically involves causing the robot to repeatedly perform a physical task in the real world. However, the costs and materials associated with training physical robots may be prohibitive. Therefore, simulated robots may be used in lieu of physical robots for training.

Conventionally, initial training of a physical robot to achieve autonomous control often includes analogously controlling the robot, wherein a human operator can see, hear, and/or feel what the robot is experiencing, and the movement of the human operator is translated into robot movement. That is, for example, the human opens their hand so the robot opens its hand, the human bends over so the robot bends over, etc.

However, training analogously is costly and impractical, as significant hardware, e.g., a pilot rig, is required, and the operation of the test robot requires a 1:1 pilot to robot ratio. Additionally, due to signal latency the pilot needs to be onsite with the robot for training/operation and not all sites have the space to accommodate a pilot rig.

An intermediate level of training, between analogous and autonomous control, wherein a human operator provides instructions to the robot allows for the robot to acquire “pieces” of autonomy which eventually work together to develop full autonomy. This intermediate level of training saves costs, due to the absence of a pilot rig, and time, due to the ability of a pilot to operate numerous instances of a robot either simultaneously or quickly in succession. However, this intermediate level of training needs to be as similar to fully autonomous control as possible in order to be effective.

Therefore, there is a need in the field for systems and methods which allow a human operator to train a robot in an equivalent system to fully autonomous control.

### BRIEF SUMMARY

Provided herein is a control system, for controlling operation of a robot in an environment, comprising a robot, including a plurality of sensors configured to convert information from the environment and the robot into sensor data, a plurality of actuators configured to cause movement of the robot; a cognitive architecture control system, communicatively coupled to the robot, configured to control the robot, and to receive the sensor data from the plurality of sensors, generate a robot-egocentric model of the environment from the sensor data, and output autonomous actuator data to the plurality of actuators of the robot, based on at least one instruction; and a graphical user interface configured to display a graphical representation of the robot-egocentric model to a human operator, wherein the human operator selects the at least one instruction from a pre-determined instruction set, based on the robot-egocentric model, to control the robot semi-autonomously.

The robot may be interchangeable between a physical robot in a physical environment and a simulated robot in a simulated environment wherein the plurality of sensors of the physical robot comprise a plurality of physical sensors generating physical sensor data from the physical environment, and the plurality of actuators of the physical robot comprises a plurality of physical actuators receiving physical actuator data, and the plurality of sensors of the simulated robot comprises a plurality of simulated sensors generating simulated sensor data from the simulated environment, and the plurality of actuators of the simulated robot comprises a plurality of simulated actuators receiving simulated actuator data.

The human operator may select, through the graphical user interface, at least one detected object within the robot-egocentric model, wherein the pre-determined instruction set is based on the selected at least one detected object.

The pre-determined instruction set may be based on a context of the at least one detected object and the robot-egocentric model.

The pre-determined instruction set may be displayed as a drop-down menu.

The cognitive architecture control system may include a feature extraction module which is configured to receive at least one sensor data stream from the robot and convert the at least one sensor data stream to features, wherein the features are semantically meaningful information, and wherein the features are used to generate the robot-egocentric model.

The features may include at least one of: location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may include a plurality of specialized submodules to each extract a feature from the at least one sensor data stream.

The control system may further comprise an attention module which is configured to turn on and off at least one of the specialized submodules.

The cognitive architecture control system may test actuator data within the robot-egocentric model to determine the effects of an actuator data driven action before sending the actuator data to the robot.

The cognitive architecture control system may include a concrete state representation updater which provides a state representation of a current state of the environment as understood by the cognitive architecture control system.

The sensor data may include at least one of audio sensor data, joint position data, pressure data, force sensitive resistor data, mobile base wheel encoder data, inertial measurement unit data, and visual data.

The actuator data may include at least one of audio data, joint position data, impedance data, and mobile base motion data.

Also provided herein is a computer program product comprising a non-transitory processor-readable storage medium storing processor-executable instructions and/or data that, when executed by at least one processor of a robot control system, cause the robot control system to receive sensor data from a plurality of sensors of a robot, generate a robot-egocentric model of an environment of the robot from the sensor data, display a graphical user interface to a human operator, wherein the graphical user interface includes a graphical representation of the robot-egocentric model and a pre-determined instruction set, receive a selection of at least one instruction from the pre-determined instruction set from the human operator, and output autonomous actuator data to a plurality of actuators of the robot, based on the selected at least one instruction.

The robot may be interchangeable between a physical robot in a physical environment and a simulated robot in a simulated environment wherein the plurality of sensors of the physical robot comprise a plurality of physical sensors generating physical sensor data from the physical environment, and the plurality of actuators of the physical robot comprises a plurality of physical actuators receiving physical actuator data, the plurality of sensors of the simulated robot comprises a plurality of simulated sensors generating simulated sensor data from the simulated environment, and the plurality of actuators of the simulated robot comprises a plurality of simulated actuators receiving simulated actuator data, and wherein, the processor-executable instructions and/or data cause the robot control system to switch between controlling the physical robot and the simulated robot.

The processor-executable instructions and/or data may allow the human operator to select, through the graphical user interface, at least one detected object within the robot-egocentric model, wherein the pre-determined instruction set is based on the selected at least one detected object.

The pre-determined instruction set may be based on a context of the at least one detected object and the robot-egocentric model.

The pre-determined instruction set may be displayed as a drop-down menu.

The control system may include a feature extraction module and the processor-executable instructions and/or data cause the feature extraction module to receive at least one sensor data stream from the robot and convert the at least one sensor data stream to features, wherein the features are semantically meaningful information, and wherein the features are used to generate the robot-egocentric model.

The features may include at least one of: location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may include a plurality of specialized submodules to each extract a feature from the at least one sensor data stream.

The control system may further comprise an attention module which is configured to turn on and off at least one of the specialized submodules.

The processor-executable instructions and/or data may cause the control system to test actuator data within the robot-egocentric model to determine the effects of an actuator data driven action before sending the actuator data to the robot.

The control system may include a concrete state representation updater and the processor-executable instructions and/or data cause the concrete state representation update to provide a state representation of a current state of the environment as understood by the cognitive architecture control system.

The sensor data may include at least one of audio sensor data, joint position data, pressure data, force sensitive resistor data, mobile base wheel encoder data, inertial measurement unit data, and visual data.

The actuator data may include at least one of audio data, joint position data, impedance data, and mobile base motion data.

Also provided herein is a method of controlling a robot by a control system, the method comprising receiving, at a cognitive architecture control subsystem of the control system, sensor data from a plurality of sensors of a robot, generating, by the cognitive architecture control subsystem, a robot-egocentric model of an environment of the robot from the sensor data, displaying a graphical user interface, to a human operator, wherein the graphical user interface includes a graphical representation of the robot-egocentric model and a pre-determined instruction set, receiving, from the human operator, a selection of at least one instruction from the pre-determined instruction set, and outputting autonomous actuator data to a plurality of actuators of the robot, based on the selected at least one instruction.

The control system may include a control-determining unit and the method further may comprise switching control between a physical robot in a physical environment and a simulated robot in a simulated environment, wherein the plurality of sensors of the physical robot comprise a plurality of physical sensors generating physical sensor data from the physical environment, and the plurality of actuators of the physical robot comprises a plurality of physical actuators receiving physical actuator data, the plurality of sensors of the simulated robot comprise a plurality of simulated sensors generating simulated sensor data from the simulated environment, and the plurality of actuators of the simulated robot comprise a plurality of simulated actuators receiving simulated actuator data.

The method may further comprise selecting, by the human operator through the graphical user interface, at least one detected object within the robot-egocentric model, wherein the pre-determined instruction set is based on the selected at least one detected object.

The pre-determined instruction set may be based on a context of the at least one detected object and the robot-egocentric model.

The pre-determined instruction set may be displayed as a drop-down menu.

The cognitive architecture control subsystem may include a feature extraction module wherein the sensor data is received by the cognitive architecture control subsystem as at least one sensor data stream, wherein the method further comprises receiving the at least one sensor data stream from the robot and converting, by the feature extraction module, the at least one sensor data stream to features, wherein the features are semantically meaningful information, and wherein the features are used to generate the robot-egocentric model.

The features may include at least one of location of detected objects, orientation of detected objects, labels of detected objects, mapping of the environment, text extracted from speech, text extracted from visual feed, facial recognition labels, presence of hand in the scene, joint states for actuators of the robot, and faces in a field of view.

The feature extraction module may include a plurality of specialized submodules to each extract a feature from the at least one sensor data stream.

An attention module which may be configured to turn on and off at least one of the specialized submodules.

The method may further comprise testing, by the cognitive architecture control subsystem, actuator data within the robot-egocentric model to determine the effects of an actuator data driven action before sending the actuator data to the robot.

The cognitive architecture control subsystem may include a concrete state representation updater, and the method may further comprise updating a concrete state representation, by the concrete state representation updater, to provide a state representation of a current state of the environment as understood by the cognitive architecture control subsystem.

The sensor data may include at least one of audio sensor data, joint position data, pressure data, force sensitive resistor data, mobile base wheel encoder data, inertial measurement unit data, and visual data.

The actuator data may include at least one of audio data, joint position data, impedance data, and mobile base motion data.

Other aspects and features will become apparent to those ordinarily skilled in the art, upon review of the following description of some exemplary embodiments.

### BRIEF DESCRIPTION OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIG. 1 is a block diagram of a robot control system comprising a robot, and a cognitive architecture control system, as described throughout the present systems, methods, and computer program products.

FIG. 2 is a block diagram showing a control system for a physical robot in accordance with the present systems, methods, and computer program products.

FIG. 3 is a block diagram showing a control system for a simulated robot in accordance with the present systems, methods, and computer program products.

FIG. 4 is a block diagram showing examples of sensor data which are sent to a control system and converted to actuator data.

FIG. 5A is a picture of a physical environment with a physical robot in accordance with the present systems, method, and computer program products.

FIG. 5B is a picture of a simulated environment with a simulated robot in accordance with the present systems, method, and computer program products.

FIG. 6 is a block diagram showing a cognitive architecture control system for a robot including a robot-perceived environment in accordance with the present robots, methods, and computer program products.

FIG. 7A is a picture of an outer world (OW) model of a simulated robot in accordance with the present systems, methods, and computer program products.

FIG. 7B is a picture showing feature extraction of the OW model of FIG. 7A in accordance with the present systems, methods, and computer program products.

FIG. 7C is an inner world (IW) model of the OW model of FIG. 7A in accordance with the present systems, methods, and computer program products.

FIGS. 8A and 8B respectively show an inner world (IW) model before (8A) and after (8B) an exemplary action is performed by a robot.

FIG. 9 is a representation of a graphical user interface (GUI) shown to a human operator for semi-autonomous (or “high-level teleoperation”) control in accordance with the present systems, methods, and computer program products.

FIGS. 10A and 10B are graphical representations of inner world models of the same environment with different detected objects recognized based on a selected category in accordance with the present systems, methods, and computer program products.

FIG. 11 is an example graphical user interface (GUI) in accordance with the present systems, methods, and computer program products.

FIG. 12 is a flow diagram of a method for controlling a robot in accordance with the present systems, methods, and computer program products.

### DETAILED DESCRIPTION

The following description sets forth specific details in order to illustrate and provide an understanding of the various implementations and embodiments of the present systems, computer program products, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present robots, computer program products, and methods.

A general-purpose robot is able to complete multiple different work objectives. As used throughout this specification and the appended claims, the term “work objective” refers to a particular task, job, assignment, or application that has a specified goal and a determinable outcome, often (though not necessarily) in the furtherance of some work. Work objectives exist in many aspects of business, research and development, commercial endeavors, and personal activities. Exemplary work objectives include, without limitation: cleaning a location (e.g., a bathroom) or an object (e.g., a bathroom mirror), preparing a meal, loading/unloading a storage container (e.g., a truck), taking inventory, collecting one or more sample(s), making one or more measurement(s), building or assembling an object, destroying or disassembling an object, delivering an item, harvesting objects and/or data, and so on. The various implementations described herein provide robots, computer program products, and methods for initializing, configuring, training, operating, and/or deploying a robot to at least semi-autonomously complete multiple different work objectives.

In at least some embodiments of the present systems, computer program products, and methods, a work objective is deconstructed or broken down into a “workflow” comprising a set of “instructions” (“instruction set”) or “work primitives”, where successful completion of the work objective involves performing each instruction in the workflow. Depending on the specific implementation, completion of a work objective may be achieved by (i.e., a workflow may comprise): i) performing a corresponding set of instructions sequentially or in series; ii) performing a corresponding set of instructions in parallel; or iii) performing a corresponding set of instructions in any combination of in series and in parallel (e.g., sequentially with overlap) as suits the work objective and/or the robot performing the work objective. Thus, in some implementations instructions may be construed as lower-level activities, steps, or sub-tasks that are performed or executed as a workflow in order to complete a higher-level work objective.

Advantageously, and in accordance with at least some embodiments of the present systems, computer program products, and methods, a catalog of “reusable” instructions may be defined. An instruction is reusable if it may be generically invoked, performed, employed, or applied in the completion of multiple different work objectives. For example, a reusable instruction is one that is common to the respective workflows of multiple different work objectives. In some implementations, a reusable instruction may include at least one variable that is defined upon or prior to invocation of the instruction.

In accordance with at least some embodiments of the present systems, computer program products, and methods, a catalog of reusable instructions may be defined, identified, developed, or constructed such that any given work objective across multiple different work objectives may be completed by executing a corresponding workflow comprising a particular combination and/or permutation of reusable instructions selected from the catalog of reusable instructions. Once such a catalog of reusable instructions has been established, one or more robot(s) may be trained to autonomously perform each individual reusable instruction in the catalog of reusable instructions without necessarily including the context of: i) a particular workflow of which the particular reusable instruction being trained is a part, and/or ii) any other reusable instruction that may, in a particular workflow, precede or succeed the particular reusable instruction being trained. In this way, a teleoperated robot may be capable of automatically performing each individual reusable instruction in a catalog of reusable instructions but still require instruction, direction, or guidance from another party (e.g., from an operator, user, or pilot) when it comes to deciding which reusable instruction(s) to perform and/or in what order. In other words, an operator, user, or pilot may provide a workflow consisting of reusable instructions to a teleoperated robot and the teleoperated robot may automatically execute the reusable instructions according to the workflow to complete a work objective. For example, teleoperated humanoid robot may be operative to look left when directed to look left, open its right end effector when directed to open its right end effector, and so on, without relying upon detailed low-level control of such functions by a third party. Such a teleoperated humanoid robot may automatically complete a work objective once given instructions regarding a workflow detailing which reusable instructions it must perform, and in what order, in order to complete the work objective. Furthermore, in accordance with the present systems, methods, and computer program products, a robot may operate fully autonomously if it is trained or otherwise configured to analyze a work objective and independently define a corresponding workflow itself by deconstructing the work objective into a reusable instruction set that the robot is operative to autonomously perform.

Reusable instructions in the catalog of reusable instructions can be organized into a plurality of sets of reusable instructions. In this sense, the catalog of reusable instructions can also be referred to as a catalog of reusable instruction sets. Each reusable instruction set includes fewer reusable instructions than the catalog of instructions; that is, each instruction set represents a subset of reusable instructions of the catalog of reusable instructions. For a given deployment, a robot may access (or have locally stored) a limited number of instructions sets, based on the nature of the deployment. This advantageously saves storage space and/or processing burden at the robot. In particular, for a general-purpose robot, a catalog of instructions usable by the robot may include an immense quantity of reusable instructions, but in many cases, a given deployment, work objective, or workflow may only require a much smaller number of reusable instructions. If the entire catalog were stored and accessed at the robot, this could significantly burden the robot. For example, when constructing or executing a workflow, it is computationally intensive for the robot to navigate through, process, or select appropriate reusable instructions from the entire catalog of instructions. In particular, a workflow is constructed of a specific combination and/or permutation of discrete reusable instructions. Each additional reusable instruction considered (i.e. available for inclusion in a workflow) exponentially increases the total number of possible workflows (because there are exponentially more possible combinations or permutations of reusable instructions), and thus also exponentially increases processing burden to identify or construct a workflow. By instead accessing one or more limited reusable instruction sets of reusable instructions, this computational burden is significantly decreased. This improves responsiveness and efficiency, and/or reduces complexity and cost of hardware of the robot. Further, the entire catalog of reusable instructions may occupy a significant amount of storage space at the robot; storing one or more limited reusable instruction sets instead of the entire catalog reduces storage burden. Thus, it is preferable to limit reusable instructions accessible to the robot to those likely to be used for a given deployment or service category in which the robot operates.

Each reusable instruction set is at least partially different from other reusable instruction sets. While reusable instruction sets may overlap and include at least one common reusable instruction (possibly many more than one), or not, each reusable instruction set includes a plurality of reusable instructions which is different by at least one reusable instruction from other reusable instruction sets. As an example, a first reusable instruction set could include at least one reusable instruction which is not included in a second reusable instruction set. The second reusable instruction set could likewise include at least one reusable instruction which is not included in the first reusable instruction set. Alternatively, each reusable instruction in the second reusable instruction set could be included in the first reusable instruction set, but the first reusable instruction set includes at least one additional reusable instruction which is not included in the second reusable instruction set (i.e., the first reusable instruction set is a larger set of reusable instructions which completely overlaps the second reusable instruction set). In such an example, the first and second reusable instruction sets are still considered “different” from each other. In some implementations, a first reusable instruction set and a second reusable instruction set may be “wholly different” from one another in that they each contain a respective unit set of reusable instructions with no overlap therebetween.

In the context of a robot, reusable instructions may correspond to basic low-level functions that the robot is operable to (e.g., autonomously, or automatically) perform and that the robot may call upon or execute in order to achieve something. Examples of reusable instructions for a humanoid robot include, without limitation: look up, look down, look left, look right, move right arm, move left arm, close right end effector, open right end effector, close left end effector, open left end effector, move forward, turn left, turn right, move backwards, and so on; however, a person of skill in the art will appreciate that: i) the foregoing list of exemplary reusable instructions for a humanoid robot is by no means exhaustive; ii) the present robots, computer program products, and methods are not limited in any way to robots having a humanoid form factor; and iii) the complete composition of any reusable instruction set depends on the design and functions of the specific robot for which the reusable instruction Setis constructed.

A robot may be operative to perform any number of high-level functions based at least in part on its hardware and software configurations. For example, a robot with legs or wheels may be operative to move, a robot with a gripper may be operative to pick things up, and a robot with legs and a gripper may be operative to displace objects. The performance of any such high-level function generally requires the controlled execution of multiple low-level functions. For example, a mobile robot must exercise control of a number of different lower-level functions in order to controllably move, including control of mobility actuators (e.g., driving its legs or wheels) that govern functional parameters like speed, trajectory, balance, and so on. In accordance with the present robots, computer program products, and methods, the high-level functions that a robot is operative to perform are deconstructed or broken down into a set of basic components or constituents, referred to throughout this specification and the appended claims as “instructions”. Unless the specific context requires otherwise, instructions may be construed as the building blocks of which higher-level robot functions are constructed.

As stated previously, the various implementations described herein provide systems, computer program products, and methods where a robot is enabled to complete multiple different work objectives. Unless the specific context requires otherwise, the terms “fully-autonomous”, “fully-autonomously”, or similar, are used throughout this specification and the appended claims to mean “without control by another party”, the terms “semi-autonomous”, “semi-autonomously”, or similar, or “high-level teleoperation” or similar, are used throughout the specification and the appended claims to mean “with limited control by another party”, and the terms “low-level teleoperation”, or similar, and “analogous”, “analogously”, or similar are used to mean “with immersive control by a pilot”.

In fully-autonomous control, a robot autonomously completes work primitives/instructions. In semi-autonomous control, a human operator provides the robot with work primitives/instructions to complete and the robot can proceed to do them. In analogous operation the robot is analogously controlled by a human pilot without using work primitives.

Training a robot has typically involved causing the robot to repeatedly perform a physical task in the real world, which can cause significant wear and tear on the components of the robot before the robot can even be deployed to perform useful work in the field. Additionally, the costs and materials associated with physical robots may be prohibitive when the success of a physical robot for a given task cannot be guaranteed. Building a physical robot is a time-consuming, expensive process compared to generating a simulated instance of a robot. The repetitions of a task that can be accomplished by a simulated robot are on a scale of hundreds, thousands, or even millions compared to a physical robot. That is, when teaching a physical robot to pick up a cup an attempt can be made once in a given period of time, while in the same period of time N simulated robots (where N could be tens, hundreds, thousands, or millions) could attempt to pick up the cup N times, depending on the computing resources. Each N instance of the simulated robot may be identical in parameters and environment to a real physical robot and to each other N simulated robot, or some of the N instances may have slight differences to optimize the process. The actuation of each simulated robot may be accelerated so that more tests can be accomplished more quickly compared to a physical robot.

Herein, systems, computer program products, and methods for controlling operation of a robot are provided.

Training a robot for a future job or task may be completed with a physical robot in a physical environment or a simulated robot in a simulated environment. Control of a robot may be achieved by a fully-cognitive architecture control system, a semi-cognitive architecture control system, or an analogous teleoperation control system, wherein fully-autonomous control uses a cognitive architecture to autonomously control the robot without input from another party (e.g., wherein an artificial intelligence determines actuation of the robot), semi-autonomous control uses a cognitive architecture to enable a human operator to control the robot with limited input, and analogous teleoperation analogously controls the robot using physical input from another party, such as a human operator or “pilot” wearing a pilot rig which relays the sensor data of the robot to the human physically (e.g., the human operator sees, hears, and feels what the robot sees, hears, and feels).

In semi-autonomous control a graphical user interface (GUI) displays robot data and options regarding possible tasks and actuations for a human operator, wherein the human operator, instead of an artificial intelligence, chooses tasks and therefore actuations through the graphical user interface. In most embodiments, the human operator views the GUI on a screen and interacts with the GUI via a keyboard, a mouse, touch (for a touchscreen) or any combination thereof. Semi-autonomous control may also be referred to as high-level teleoperation.

Therefore, when training a robot there are six possible scenarios: i) fully-autonomous control of a physical robot, ii) semi-autonomous control of a physical robot, iii) analogous control of a physical robot iv) fully-autonomous control of a simulated robot, v) semi-autonomous control of a simulated robot, and vi) analogous control of a simulated robot.

Herein, fully autonomous control and semi-autonomous control are discussed wherein semi-autonomous control is used to enable and ensure proper fully autonomous control.

The use of a simulated robot in a simulated environment is intended to replicate a physical robot in a physical environment such that control or training of the simulated robot can be taught or achieved without requiring a physical robot. For example, a pilot could learn to analogously control a simulated robot instead of learning to control a physical robot, thus eliminating risks to a physical robot. In another example, a user wishing to determine if a robot can accomplish an intended task can use a simulated robot in a simulated environment to train and analyze the simulated robot for the task without the need to acquire the physical robot. In yet another example, a user may want to train a robot to be able to perform a task through analogous control but also want the robot to be able to perform the task autonomously (fully- or semi-).

While a primary advantage of semi-autonomous control is that it enables accurate training for fully autonomous control, a secondary advantage is that there is no need for specialized gear as in analogous control. Semi-autonomous control only requires a screen and at least one input device such as a keyboard and/or a mouse.

The systems, computer program products, and methods provided herein are concerned with enabling semi-autonomous control of a physical or simulated robot, wherein a human operator controls the robot only within the context of what is perceived and understood by the robot.

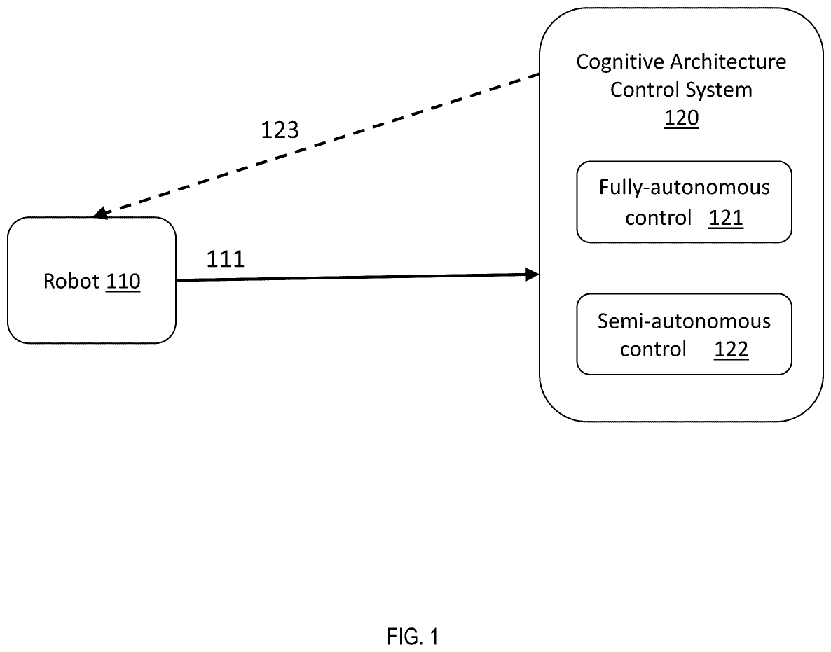

FIG. 1 is a block diagram, high-level representation, of a robot control system 100 comprising a robot 110 and a cognitive architecture control system 120, as described throughout the present systems, methods, and computer program products.

Cognitive architecture control system 120 enables both fully autonomous control 121 and semi-autonomous control 122 of robot 110. Robot 110 is communicatively coupled to cognitive architecture control system 120.

Robot control system 100 is shown at a high level. It is to be understood that robot 110 and cognitive architecture control system 120 include other components.

Robot 110 exists within an environment. Robot 110 may be a physical robot in a physical environment or a simulated robot in a simulated environment.

Robot 110 includes a plurality of sensors which convert information from the environment and the robot into sensor data 111. Robot 110 includes a plurality of actuators which control movement of the robot.

Cognitive architecture control system 120 controls which one of fully-autonomous control 121 and semi-autonomous control 122 is used to control the robot. In some circumstances the cognitive architecture may identify that control needs to be switched from fully-autonomous control 121 to semi-autonomous control 122, for example, when an unexpected result occurs or when the fully-autonomous control does not know how to proceed. In some circumstances, the human operator may identify that the control needs to be switched from fully autonomous control 121 to semi-autonomous control 122 (or vice versa) and switch the control through a graphical user interface (GUI) of the cognitive architecture control system 120.

In some embodiments, robot 110 may also be controlled analogously by a separate analogous control system, and a control-determining system may be present to determine which of the analogous control system of the cognitive architecture control system 120 has control of robot 110.

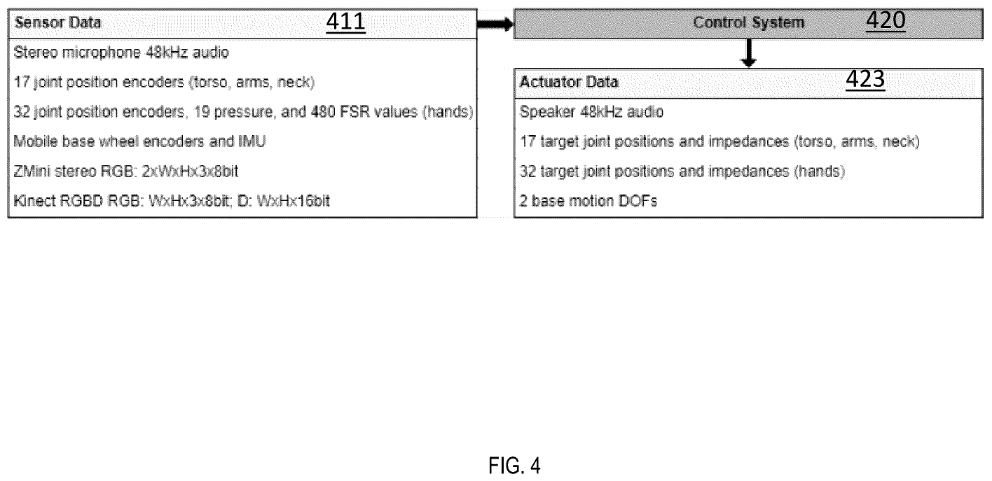

Regardless of fully autonomous control 121 or semi-autonomous control 122, the cognitive architecture system 120 converts sensor data 111 into actuator data 123 to control the actions of robot 110. Exemplary sensor data and actuation data are shown and described in FIG. 4.

Cognitive architecture control system 120 sends actuator data 123 to robot 110 to cause robot 110 to perform a task. Broadly, when the control of robot 110 is set to fully-autonomous control, an artificial intelligence causes the robot 110 to perform actions based on received sensor data 111, and when the control of robot 110 is set to semi-autonomous, sensor data 111 is displayed to the human operator viewing the GUI representing sensor data 111 and the human operator causes the robot to perform actions based on the sensor data 111. In both circumstances, the actions are chosen from a pre-defined instruction set. The instruction set may include work objectives and work primitives as described above.

Specifically, sensor data 111 is sent to cognitive architecture control system 120 as a raw sensor data stream comprising sensor data packets. The sensor data packets have a data type, e.g., audio data, visual data, digital data, etc., a size, and a frequency at which the packets are sent.

Actuator data 123 is sent to robot 110, to control the movement of robot 110, as an actuator data stream having a data type, a size, and a frequency. The data type, size, and frequency are the same for fully autonomous control 121 and semi-autonomous control 122.

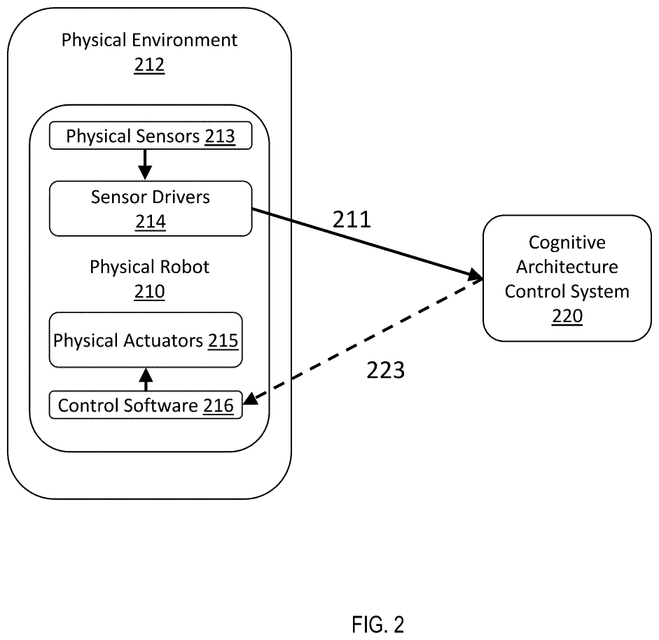

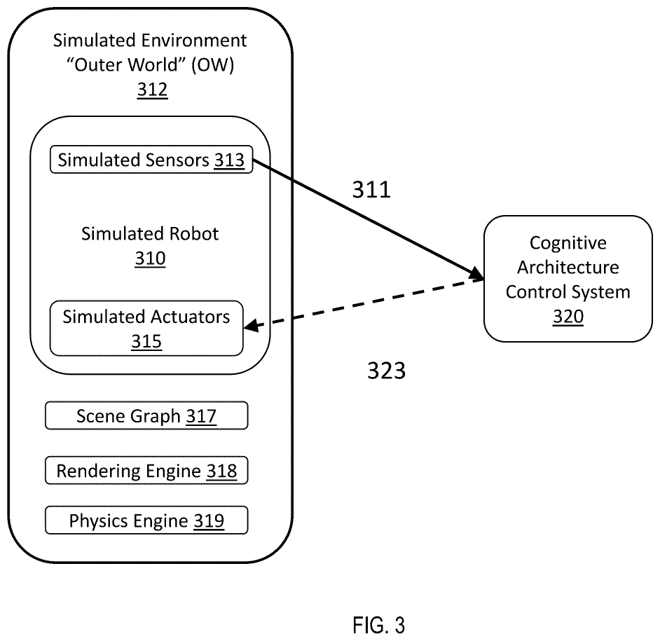

As mentioned above, robot 110 may be a physical robot in a physical environment or a simulated robot in a simulated environment. FIG. 2 shows a physical robot and FIG. 3 shows a simulated robot.

FIG. 2 is a block diagram showing a control system 200 for a physical robot 210 in accordance with the present systems, methods, and computer program products. Control system 200 includes physical robot 210 and a cognitive architecture control system 220. Cognitive architecture control system 220 may be similar to cognitive architecture control system 120 of FIG. 1 and is capable of fully autonomous control and semi-autonomous control.

Physical robot 210 exists within a physical environment 212.

Physical robot 210 comprises a plurality of physical sensors 213 which generate data from physical environment 212 by sending sensor signals to a plurality of sensor drivers 214. The sensor drivers 214 send a raw sensor data stream to cognitive architecture control system 220.

Physical robot 210 comprises a plurality of physical actuators 215 which are controlled by a control software 216. The control software receives actuator data from cognitive architecture control system 220.

Cognitive architecture control system 220 sends actuator data 223 to physical robot 210 to cause physical robot 210 to move, e.g., to perform a task. Under fully autonomous control, cognitive architecture control system 220 and physical robot 210 perform tasks without input from another party (e.g., a pilot). Under semi-autonomous, there is limited input from a human operator through a GUI. In both circumstances, actions are chosen from a pre-defined set of instructions.

FIG. 3 is a block diagram showing a control system 300 for a simulated robot 310 in accordance with the present systems, methods, and computer program products.

Control system 300 includes simulated robot 310 and a cognitive architecture control system 320.

Simulated robot 310 “exists” within a simulated environment 312 or “outer world” (OW) model. The simulated environment is a pre-constructed simulation environment, similar to, for example, a video game world or other sim world. An OW model may be an analogous recreation of a real-world environment but does not need to be. The simulated environment simulates the physics and relative scale of objects in the real-world to enable accurate robot operation. Of note, there is no connection between an OW model of simulated robot 310 and a physical robot operating in real-time. However, simulated robot 310 needs to operate analogously to a physical robot to ensure that a physical robot would operate in a physical environment in the same way simulated robot 310 operates within simulated environment 312. To that end, simulated robot 310 may be modelled after a real-world robot counterpart or at least real world sensors and actuators.

The OW model is generated by a scene graph 317, a rendering engine 318, and a physics engine 319. Scene graph 317 is a data structure providing a logical and spatial representation of the simulated environment. Rendering engine 318 is software which continuously generates the model using the graphical scene. Physics engine 319 is software which ensures that the physical aspects of the model (e.g., gravity) are correct.

Simulated robot 310 comprises a plurality of simulated sensors 313 which generate data from simulated environment 312. Simulated sensors 313 send a raw sensor data stream of simulated data to cognitive architecture control system 320 as sensor data 311. Each of the simulated sensors 313 is analogous to a respective physical sensor of a real-world physical robot counterpart of simulated robot 310.

Simulated robot 310 also comprises a plurality of simulated actuators 315. The simulated actuators 315 receive actuator data 323 from cognitive architecture control system 320. Each of the simulated actuators 315 is analogous to a respective physical actuator of a real-world physical robot counterpart of simulated robot 310.

Cognitive architecture control system 320 sends actuator data 323 to simulated actuators 315 to cause simulated robot 310 to move, e.g, to perform at least one work task. In a fully autonomous control scenario, cognitive architecture control system 320 and simulated robot 310 perform work tasks without input from another party. In a semi-autonomous control scenario, there is limited input from a human operator viewing a GUI displaying information about robot 310 and simulated environment 312.

The data type, size, and frequency of a raw sensor data stream of sensor data 311 is approximately identical to sensor data which would be generated by a “real-world” physical robot counterpart (e.g., 211 from FIG. 2).

FIG. 4 is block diagram showing examples of sensor data 411 which are received by a control system 420 and actuator data 423 which may be generated based on the sensor data 411.

The example sensor data includes:
i) stereo microphone 48 kHz audio
ii) 17 joint position encoders (including torso, arms, neck, etc.)
iii) 32 joint position encoders, 19 pressure values, and 480 FSR values (hands)
iv) mobile base wheel encoders and IMU
v) ZMini steror RGB: 2×W×H×3×8 bit
vi) Kinect RGB: W×H×3×8 bit, D: W×H×16 bit

The actuator data includes:
i) speaker 48 kHz audio
ii) 17 target joint position and impedances (torso, arms, neck)
iii) 32 target joint positions and impedances (hands)
iv) 2 base motion degree of freedom (DOFs)

Table 1, below, shows additional types of sensor data which could be captured for a physical robot or a simulated robot. The size and frequency of the data packets of the data stream of the sensor data is also shown. As described above, the size and frequency of the sensor data packets (or the actuation data packets) are identical or nearly identical regardless of whether the robot is a simulated robot or physical robot or whether the control is fully-autonomous or semi-autonomous (or analogous). As described above, the simulated robot is generated to match a real (existing or not yet existing) physical robot and therefore the sensor data types and formats are the same (identical or so close as to be identical) between the simulated robot and the real physical robot it represents.

TABLE 1
Sensor Data Type/Format

Joint states (position, velocity, torque) /2 kB@1 kHz
Haptic feedback (fingers) / 1 kB@200 Hz
Link health and critical telemetry / 1 kB@100 Hz
Commands (position, velocity torque) / 2 kB@1 kHz
Hand poses and configurations / 1 kB@200 Hz
Localization and mapping / 100 B@100 Hz
Depth camera / 5 mB@30 Hz
Stereo camera / 10 mB@90 Hz
Microphones / 50 kB@90 Hz
Speakers / 1 kB@50 Hz
Environment motion (mobile base and legs) / 100 B@100 Hz
Logs / 10 GB@1 h
System status / 10 kB@1 Hz
Management / 1 kB@0.1 Hz
Unit configuration / 1 kB@0.1 Hz or 100 mMB@1 d
Mode of operation / 100 B@0.5 Hz
Upper torso trajectory / 1 kB@0.5 Hz < 10 samples
Touch State / 1 kB@100 Hz < 10 samples
Warning and alarms / 100 kB@10 Hz < 100 samples
Acknowledge and bypass / 10 kB@1 Hz < 10 samples
Motion configuration requests / 1 kB@1 Hz < 10 samples
Upper torso motion requests / 1 kB@010 Hz < 100 samples

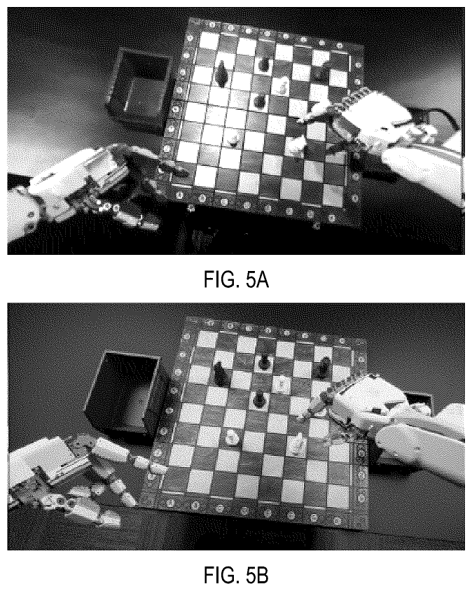

FIG. 5A is a picture of a physical environment with a physical robot in accordance with the present systems, method, and computer program products. FIG. 5A shows a physical robot playing a game of chess.

FIG. 5B is a picture of a simulated environment with a simulated robot in accordance with the present systems, method, and computer program products. FIG. 5B shows a simulated robot playing a game of chess.

It can be seen that many elements within the environment of FIG. 5A are the same as FIG. 5B, e.g., the positions of the table, chess board, chess pieces, robot arms, robot hands, robot fingers, the blue receptacles.

The simulated environment of FIG. 5B not only matches the appearance of FIG. 5A, but invisible physical properties, such as gravitational constant, mass of objects, surface hardness/conformity, etc. are designed to match those of the real environment of FIG. 5A.

In FIGS. 5A and 5B, the robots may be controlled fully-autonomously or semi-autonomously (or in some embodiments analogously).

FIG. 5A represents a real-world physical environment while FIG. 5B represents the OW model of the simulated environment of the simulated robot. However, neither of these images represent what the robot perceives the environment to be.

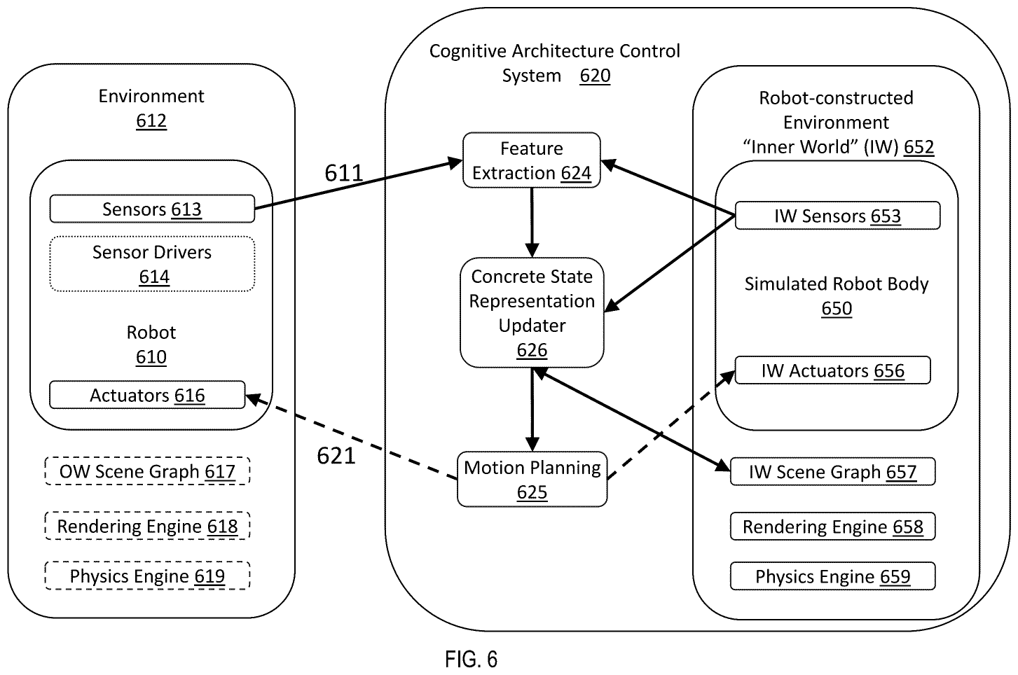

As described above, herein semi-autonomous control of a robot by a human operator is meant to mimic as closely as possible fully autonomous control of the robot. To that end the present systems, computer program products, and methods are concerned with enabling semi-autonomous control of a physical or simulated robot, wherein a human operator controls the robot only within the context of what is perceived and understood by the robot as occurs in fully autonomous control. Below and in FIG. 6, how a cognitive architecture control system enables this robot perception-centric control, is described and shown.

A representation of a robot's perception of its environment (be it physical or simulated) is generated as an “inner world” (IW) model or “robot-perceived environment”. The robot-perceived environment may have all of the same parts as an OW model (i.e., a pre-constructed environment) or physical environment. The IW model is a robot-egocentric model which the cognitive architecture control system creates to represent the robotic perception of OW or physical environment using the robot sensor data.

The IW model is analogous to a human mind's understanding or construction of the external environment. For example, when a human enters a room the understanding of the room within the human mind is based on what is perceived. There are unknowns about the room until the mind can collect more data (e.g., what is behind the human can be determined by turning around).

To that end, the IW model is fundamental to how a robot operates under autonomous control. Reasoning, planning, deduction, and learning are all based on the IW model. For autonomous control (fully or semi-), all control is executed based on the inner world model regardless of whether the system is controlling a real-world robot in the real-world or a simulated robot in a simulated world. That is, when controlling a real-world robot in the real world, the cognitive architecture control system creates an inner world model in real-time and all robot actuation is rooted in this IW model. Likewise, when controlling a simulated robot in a simulated OW model, the cognitive architecture control system creates an IW model of the OW model and all robot actuation is rooted in this IW model.

Cognitive scientists are largely united in the view that human cognition is object-centric. Therefore, the models discussed herein focus on objects (including the robot's own body and its parts), relationships between objects, and object-focused temporal events (such as collisions between objects). Because of this, in both OW and IW models, environments are built out of the composition of objects (including object-focused temporal events).

When the robot-perceived environment is created for a simulated robot, the IW model may use the exact same machinery as the OW model simulation, and includes a model of the robot's body from the perspective of the robot. The IW model is dynamically generated by a cognitive architecture of the cognitive architecture control system. This is shown in FIG. 6.

When the robot-perceived environment is created for a physical robot, the IW model may use the same machine as is used to generate an OW model simulation, and also includes a model of the physical robot's body from the perspective of the robot. The IW model is dynamically generated by the cognitive architecture of the cognitive architecture control system. This is also shown in FIG. 6.

While an OW model may be used for both autonomous control and analogous control of a simulated robot, the IW model is employed only for fully autonomous control or semi-autonomous of either a simulated robot or a physical robot. That is, there is no IW model employed in analogous operation of a robot.

In semi-autonomous control, wherein a human operator is shown a GUI in order to choose actions for a robot, the human operator is shown only the IW model. To facilitate fully autonomous control of a robot it is important that, during semi-autonomous control, the human operator knows only what the robot “knows”. When the human operator only sees what is in the robot's “mind”, a reason (or reasons) why the robot is failing to complete a task can be determined. That is, the robot may not be creating a sufficient inner world to achieve fully autonomous control.

It is also important that the human operator only be able to give instructions to the robot that could be given under fully autonomous control. Therefore, the human operator is only shown instructions from the same instruction set which is available in the same scenario in fully autonomous control.

FIG. 6 is a block diagram showing a cognitive architecture control system 620 for a robot 610 including a robot-perceived environment or inner world (IW) 652 in accordance with the present robots, methods, and computer program products.

Robot 610 may be a physical robot or a simulated robot. When robot 610 is a physical robot, the robot may be similar or identical to physical robot 210 of FIG. 2. When robot 610 is a simulated robot, the robot may be similar or identical to simulated robot 310 of FIG. 3.

Robot 610 exists within an environment 612. When robot 610 is a physical robot, environment 612 is a physical environment. When robot 610 is a simulated robot, the environment is a simulated environment or “outer world” (OW) model as described in FIG. 3. An OW model may be an analogous recreation of a real-world environment but does not need to be. Of note, there is no connection between an OW model of a robot and a physical robot operating in real-time.

If robot 610 is a simulated robot, robot 610 includes a scene graph 617, a rendering engine 618, and a physics engine 619 (shown in dashed lines to represent that these elements would not be present for a physical robot).

Robot 610 comprises a plurality of sensors 613 which generate data from environment 612. Sensors 613 send a raw sensor data stream 611 to cognitive architecture control system 620.

For a simulated robot 610, each of the sensors 613 is analogous to a respective physical sensor of a real-world physical robot counterpart.

For a physical robot 610, sensors 613 have sensor drivers 614 (shown in dotted lines to represent that these elements would not be present for a simulated robot).

Robot 610 comprises a plurality of actuators 615. The actuators 615 receive actuator data 624 from cognitive architecture control system 620.

When robot 610 is a simulated robot, each of the simulated actuators 615 is analogous to a respective physical actuator of a real-world physical robot, although as above, there is no connection between a simulated robot and a physical robot operating in real-time.

Cognitive architecture control system 620 is a computing device system including at least one processor and at least one memory. In embodiments where autonomous control is semi-autonomous, the system also includes at least one graphical user interface device (e.g., display or monitor) to display a graphical user interface for a human operator and at least one input device (e.g., keyboard, mouse, and/or touchscreen) to receive input from the human operator.

Cognitive architecture control system 620 includes a feature extraction module 624, a motion planning submodule 625, and concrete state representation updater (Concrete SRU) module 626. Cognitive architecture control system 620 receives raw simulated sensor data stream 611 from simulated sensors 613 and generates a “robot-perceived environment” or “inner world” (IW) model 652. IW model 652 is a robot-egocentric model of the OW of the robot 610 which includes a simulated robot body 650 comprising a model of the body of the robot as perceived by the robot, inner world sensors 653, and inner world actuators 656. The inner world sensors 653 are simulated sensors which are analogous to the simulated sensors 613. The inner world actuators 656 are simulated actuators which are analogous to the simulated actuators 616. The IW model 652 is generated by an IW scene graph 657, a rendering engine 658, and a physics engine 659.

Because the raw simulated sensor data stream 611 only represents what the robot 610 has perceived about the OW environment 612, the information used to generate the IW model 652 is incomplete compared to the actual OW environment 612. There is more information within the OW 612 than the robot 610 can perceive. Not only is the information perceived by the robot 610 limited compared to the actual OW information available but at least some of the information may be wrong. For example, a simulated robot may perceive an apple as a ball. Generating the IW model 652 allows the cognitive architecture control system 620 to imagine what the effects of action-taking would be inside if the IW model 652 of the OW 612 before having to commit to actually taking those actions in the OW 612. This machinery allows cognitive architecture control system 620 to ‘think about the world’, and predict what will happen in the future, as well as to learn from mistakes and make corrections. Within the IW model, objects which have been perceived by the robot 610, or “detected objects” determine the instruction sets which are possible. If the detected objects are detected incorrectly (or an object is not detected at all) the instruction sets may not be correct for the actual OW environment 612. For example, if the robot has perceived an apple to be a ball resulting in an interaction with the apple not going as anticipated, the apple can be better characterized going forward.

In fully-autonomous control, an artificial intelligence chooses at least one instruction from a pre-determined instruction set. In semi-autonomous control, a human operator chooses at least one instruction from a pre-determined instruction set. The human operator views the IW model on a GUI and may select objects from the detected objects wherein the pre-determined instruction set is dependent on the selected detected objects. The instruction set may be provided as a drop-down menu.

Cognitive architecture control system 620 uses feature extraction module 624 to generate the IW model 652.

Feature extraction module 624 takes low-level, sub-symbolic, high bandwidth, complex sensory data streams, including raw video, audio, proprioceptive and haptic streams, and converts them into high-level, symbolic, semantically meaningful information called features. Feature extraction module 624 extracts features from both the robot 610 in OW 612 and the simulated robot body 650 in IW 652.

Feature extraction is the first step in the process that cognitive architecture control system 620 uses to understand the OW 612. Cognitive architecture control system 620 allows arbitrary addition and removal of feature extractor functions within the feature extraction module 624 which act on the raw simulated sensor data stream 611 and data from inner world sensors 653. Each feature extractor is a specialized submodule of the feature extraction module 624 that can be turned on or off. The specialized submodules may be turned on and off by an attention module.

Some feature extractors run all of the time and publish extraction results continuously, but most feature extractors run only when needed.

Examples of some of the feature extractors that are implemented in the feature extraction module 624 include:
The location, orientation, and labels of all detected objects (inverse graphics)
Mapping of the environment (multi-resolution SLAM)
Text extracted from speech (speech to text)
Text extracted from OCR on visual feed (reading text)
Name labels extracted from recognizing specific people (facial recognition).

The presence or absence of a hand in the scene
Joint states for all actuators in the robot
Number of faces in the field of view

IW model 652 is generated using features which are extracted by feature extraction module 624. The extracted features provide important data and context for informing the pre-determined instruction sets.

Motion planning module 625 enables cognitive architecture control system 620 to plan what motion the robot 610 in the OW model 612 and the simulated robot body 650 in the IW model 652 will take.

The feature extraction module 624 extracts features from data generated by the inner world sensors 653 in IW model 652. As described above, this allows cognitive architecture control system 620 to predict the effects of certain actions planned by motion planning module 625 within IW model 652 by simulated robot body 650 before enacting those actions within OW model 612 by robot 610.

The concrete SRU module 626 receives feature extraction data from the feature extraction module 624 as well as data from the inner world sensors 653 and data from the IW scene graph 657 to generate a state representation of the IW model. The state representation represents a current understanding that the cognitive architecture control system 620 has about the OW 612 and the position of the robot 610 within the OW 612.

The state representation is data which semantically represents the current state of the OW (as characterized in the IW) in contrast to the IW itself which continuously varies and may be used to dynamically predict actions. That is, the state representation is a “snapshot” of the current state of the IW which the cognitive architecture control system can use to inform the pre-determined instruction sets which are provided as. The state representation collects data streams from the inner world sensors 653, the IW scene graph 657, and feature extraction module 624 and turns the data into semantically meaningful data, e.g., “there is a cup on the bottom left corner of the table”. The scene graph includes the locations of any objects or people, the exact pose of the robot body, what task the robot is currently executing (e.g., the robot is executing a hand wave of the left hand). In a fully autonomous control situation, the objects and locations may be referred to by data points and coordinates, e.g., “move data point X to coordinates X, Y, Z”, while in a semi-autonomous control situation the objects and locations may be referred to with names, e.g., “move the apple to the middle of the tray”.

Importantly, in FIG. 6, and in all embodiments, the data received by cognitive architecture control system 620 from a physical robot 610 and the data received by cognitive architecture control system 620 from a simulated robot 610 is identical in type, frequency, and size.

The cognitive architecture control system 620 cannot identify from the data streams 611 whether the data is received from a simulated robot or a physical robot. IW model 652 cannot be distinguished as perceived by a simulated robot or a physical robot. That is, in fully autonomous control an artificial intelligence controlling a robot may, by design, not know from the incoming data streams or from the IW model whether the robot sending the data stream is a simulated robot in an OW or a physical robot in a physical environment. As well, in semi-autonomous control a human operator controlling a robot could not know from the IW model, other data, or task options presented on a graphical user interface of the cognitive architecture control system whether the robot sending the data stream is a simulated robot in an OW or a physical robot in a physical environment.

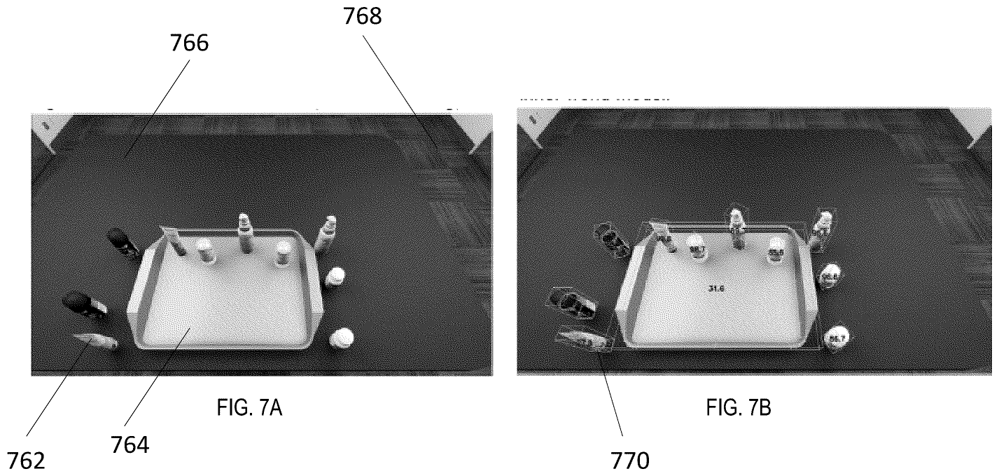

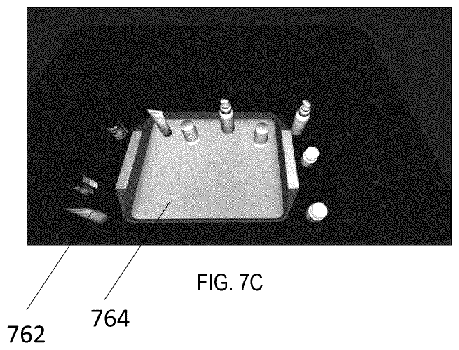

FIGS. 7A-C represent an outer world model, a feature extracted outer world model, and an inner world model, respectively. FIG. 7A shows a photo from a video feed of a simulated robot in a simulated environment, i.e., an OW. The simulated environment includes small items 762 (only one labelled to reduce clutter) on and around a tray 764 which is on a table 766 which is on a floor 768. FIG. 7B shows the same photo with feature extraction. Each object within the photo has the position and orientation of the object extracted as shown by the green rectangular prisms surrounding each object. Only small items 762 and tray 764 have been identified as objects. FIG. 7C shows an IW model representation of the outer world of FIGS. 7A and 7B as perceived by the simulated robot. FIG. 7C clearly shows the small items 762 and tray 764 which the robot has perceived within the outer world but lacks detail of the table or the floor which the objects are situated on. In this situation, feature extractors which extract the small items 762 and tray 764 have been turned on but not feature extractors which extract the table or floor. The robot may be able to perform actions such as moving the smaller items 762 onto/off of the tray 764, but if tasked with moving the tray 764 onto the floor 768 feature extractors for those features would need to first be turned on.

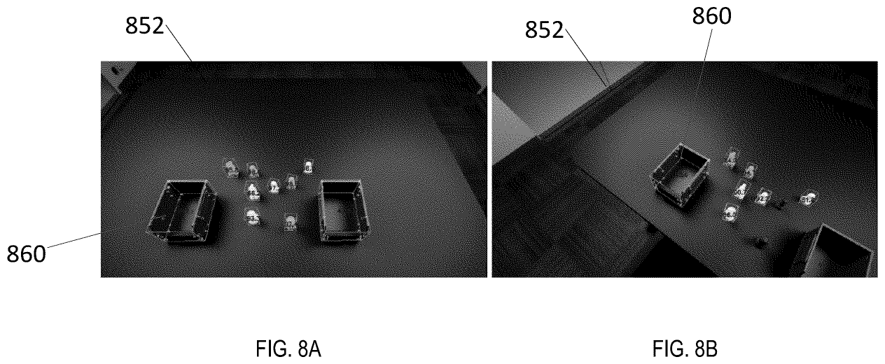

FIGS. 8A and 8B show an IW model 852 before and after an action has been taken.

An instruction set, as also described above, acts as a boundary between the sub-symbolic realm of physics (voltages and currents) and the symbolic realm of human-readable representations and semantics. The instruction set is the lowest level of abstraction available for programming a processor, such as the processor(s) in the robots and control systems discussed herein. Higher level languages are compiled down to sequences of the instructions in the instruction sets. The combinatorial orderings of instructions contains within it all possible programs, in a similar way that all possible combinations of characters in the English alphabet contains all possible English writing.

Possible actions that can be performed by the robot are sequences of symbolic tokens, each of them corresponding to one of the allowed instructions together with symbolic parameters. Each of the instructions is implemented as a closed loop control algorithm where success conditions are defined by Boolean functions called percepts. The process of using policies to generate robot joint trajectories is called “motion planning” as described above. Percepts are extracted from sensory data and are definitionally what is meant as “success” in the execution of an instruction.

In FIGS. 8A and 8B an example of an action performed by a robot is shown.

The instruction for the action is “set_self_look_at_object($OBJ_UID)”. The semantic meaning of this instruction is that the robot is asked to center its visual gaze on a specific object that the system has assigned a particular identification integer to (for example, $OBJ_UID=5 in FIGS. 8A and 8B, which is the blue bin 860 on the left). The instruction sets a system goal of having the associated percept be true, and follows an engineered policy to achieve this goal.

The percept in this case is a Boolean function is_self_looking_at_object($OBJ_UID) that returns true when the robot's visual system has the object identified as $OBJ_UID centered in its field of view within some tolerance. The policy followed to achieve this goal in this case is a closed-loop control algorithm that uses incoming visual data to reduce the distance between the center of the camera field of view to coincide with the center of mass of the object.

The IW model 852 of FIGS. 8A and 8B are shown from the first person perspective of the cameras of the robot. The system has assigned the leftmost blue bin 860 $OBJ_UID=5. For FIG. 8A, the percept “is_self_looking_at_object(5)” associated with “set_self_look_at_object(5)” is false (the center of the object is too far from the center of the field of view). The policy is a closed loop control algorithm that moves the actuators in the robot towards centering the object. In FIG. 8B, “is_self_looking_at_object(5)” is true and the instruction “set_self_look_at_object(5)” is reported to be successfully executed.

In a computer processor, an instruction might ask that a specific bit in a memory register be set to 0. When that Instruction is executed, analog currents and voltages flow in the physical structures that comprise the processor, but the final result is a symbolic outcome (the bit in question is either 0 or 1). In our architecture, when a command like “set_self_look_at_object($OBJ_UID)” is issued, just like in a processor, analog physics occurs in the actuators and sensory data, but the final result is a symbolic outcome, just like it is in a digital system (the percept “is_self_looking_at_object($OBJ_UID)” is either 0 or 1).

This pattern is required of all instructions in an instruction set. All of the instructions come with clear human-readable semantic meanings; they are all specified entirely symbolically, including their parameters; each comes with a percept, which is a Boolean function of sensory data; each comes with a policy whose goal is making the percept true; executing this policy is also called motion planning. This pattern digitizes action-taking, allowing controllers to compile higher level task plans down to the instruction set.

In semi-autonomous control the human operator is constrained in the possible actions they can take by the instruction set which is available to them. The instruction set available is identical to the instruction set that would be available to an artificial intelligence in fully-autonomous control. The human operator cannot cause the robot to perform any actions which the artificial intelligence would not be able to cause.

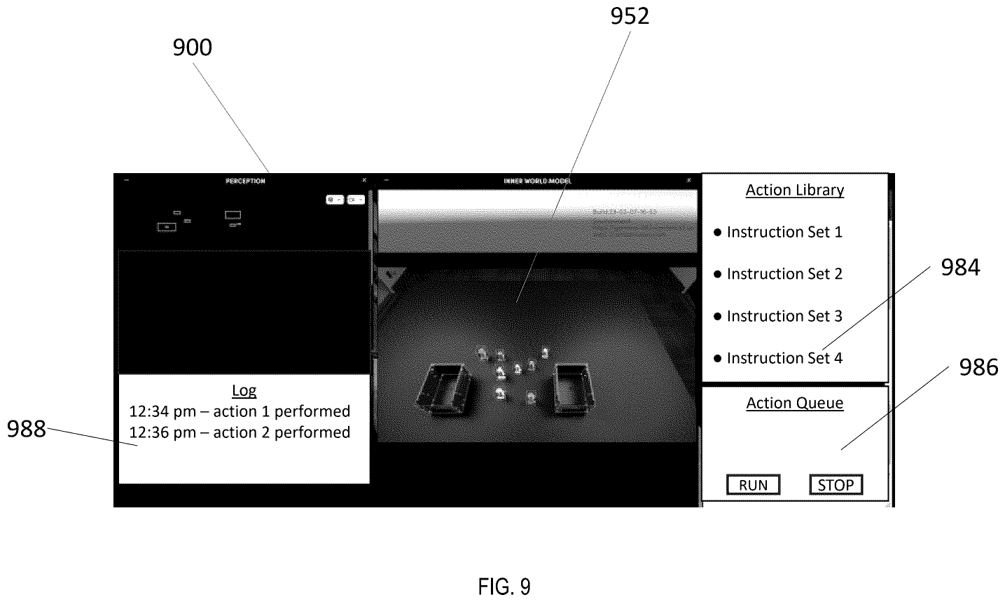

FIG. 9 is a representation of a graphical user interface (GUI) 900 shown to a human operator for semi-autonomous (or “high-level teleoperation”) control. The GUI 900 is presented to the human operator on some type of screen, for example, a laptop screen, or a tablet screen.

GUI 900 includes a visualization of an inner world model 952 (Identical to IW model 852 of FIG. 8A). In IW model 952 there are ten detected objects, including eight small items and two receptacles all sitting on the same surface. The green lines around the small items and receptacles represent feature extraction of objects. From the IW model 982 the human operator knows that the robot is perceiving these ten objects and knows the orientations and positions of the objects within the environment. Importantly, the GUI only shows human operator information which is created from the perception of the robot. The human operator does not access any direct feeds from the outer world, e.g., camera views from the perspective of the robot or from a perspective within the environment that is not the environment of the robot.

The GUI 900 includes a list of actions (i.e., “instructions” or “work primitives”), in an action library 984, which can be performed by the robot. The actions displayed in action library 984 are from an instruction set identical to an instruction set that would be used by the cognitive architecture control system in fully autonomous control. For some actions, the human operator may select at least one object from the IW model 952 shown in the GUI 900 and is shown within the action library 984 the possible actions that can be taken with the object. That is, a set of all possible instructions may be displayed when no objects are selected and a refined set of instructions based on selected objects may be shown when an object is selected. The human operator may select object by any appropriate input means, for example, a mouse, a keyboard, a touchscreen, etc. The human operator may select a detected object to receive an instruction set which lists only those actions which can be taken with the selected detected object. The instruction set may comprise a drop-down menu of the possible actions. Each of the detected objects may have a drop-down menu which lists the possible actions which can be taken with the respective detected object. The human operator may be shown all possible actions which can be taken for the ten detected objects. The possible actions may be informed by the context of the OW environment and the detected objects as perceived by the robot. Some actions may not require the human operator to select an object but to only select an instruction, for example to control locomotion of the robot.

The GUI 900 includes an action queue 986 which is a list of the next actions which are to occur. That is, the human operator can pick several actions and an order for those actions to be taken and add those to a plan to be followed. The action queue 986 includes a RUN button and a STOP button which the human operator can use to start and stop the actions of the robot.

The GUI 900 includes a log 988 which keeps a record of the actions that have already been taken by the robot.

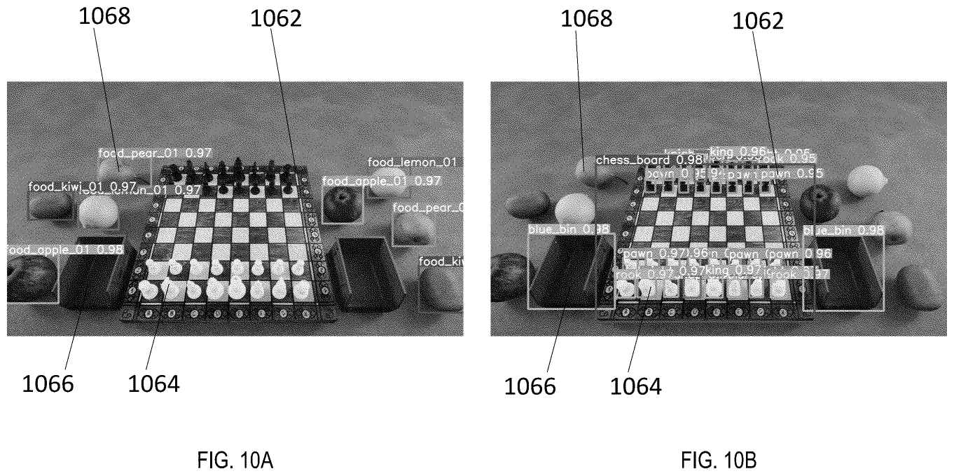

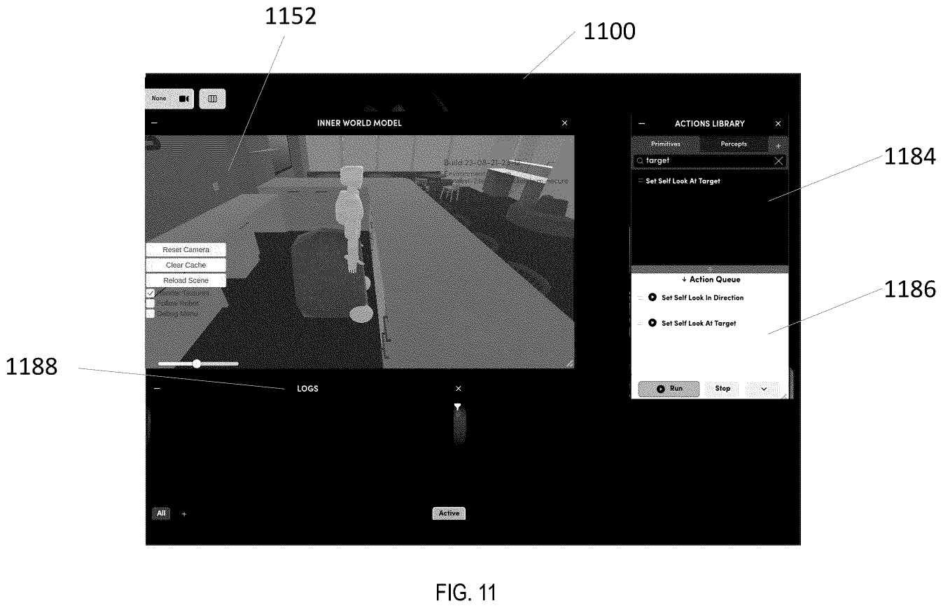

FIGS. 10A and 10B show the same IWM of the same environment with different detected objects recognized based on a selected category. In FIGS. 10A and 10B, the environment includes a surface upon which a chessboard 1062 and chess pieces 1064, two bins 1066, and eight fruit 1068 sit.

In FIG. 10A, the eight fruit 1068 are the selected detected objects. A context may have been provided through a GUI of the cognitive architecture control system that the desired tasks will involve food and therefore fruit 1068 have been selected from among the detectable objects. Selecting only fruit 1068 may be accomplished by turning on feature extractors for food (or more specifically fruit) and possibly turning off other feature extractors. In other embodiments, fruit 1068 may have been manually selected, from among all of the robot-perceived objects, by a human operator. When fruit 1068 are the selected detected objects the instructions available to be chosen by the human operator (or artificial intelligence) and performed by the robot will include fruit 1068. Chessboard 1062, chess pieces 1064, and bins 1066 have not been selected and, therefore, the possible instruction sets will not include actions involving those objects. While the robot has identified fruit 1068 in FIG. 10A, the robot still needs to recognize that other objects (chessboard 1062, chess pieces 1064, and bins 1066) are present, as well as the location, size, and shape of the objects, in order for the robot to perform tasks in the environment with fruit 1068.

In FIG. 10B, a context has been provided, through the GUI of the cognitive architecture control system that the desired tasks will involve chess and, therefore, chessboard 1062, chess pieces 1064, and bins 1066 have been selected from among the detectable objects. Selecting chessboard 1062, chess pieces 1064, and bins 1066 may be accomplished by turning on feature extractors for “games” or “chess” and possibly turning off other feature extractors. In other embodiments, chessboard 1062, chess pieces 1064, and bins 1066 may have been manually selected, from among all of the robot-perceived objects, by a human operator. When chessboard 1062, chess pieces 1064, and bins 1066 are the selected detected objects the instructions available to be chosen by the human operator (or artificial intelligence) and performed by the robot will include chessboard 1062, chess pieces 1064, and bins 1066. Fruit 1068 have not been selected and, therefore, the possible instruction sets will not include actions involving fruit. While the robot has identified chessboard 1062, chess pieces 1064, and bins 1066 in FIG. 10A, the robot still needs to recognize that fruit 1068 are present, as well as the location, size, and shape of fruit 1068, in order for the robot to perform tasks in the environment with chessboard 1062, chess pieces 1064, and bins 1066.

FIG. 11 shows an example embodiment of a GUI 1100. The GUI 1100 includes an IW model 1152 from an external view which represents the robot's perception or understanding of its own position within the environment. Similarly to GUI 900 of FIG. 9, GUI 1100 includes an action library 1084, an action queue 1086, and a log 1088. In FIG. 11, a target has been selected and the action library 1084 includes an instruction for the possible action of the robot looking at the target. The action queue 1086 includes instructions to “Set Self Look In Direction” and “Set Self Look At Target”. The log 1088 does not include any actions yet.

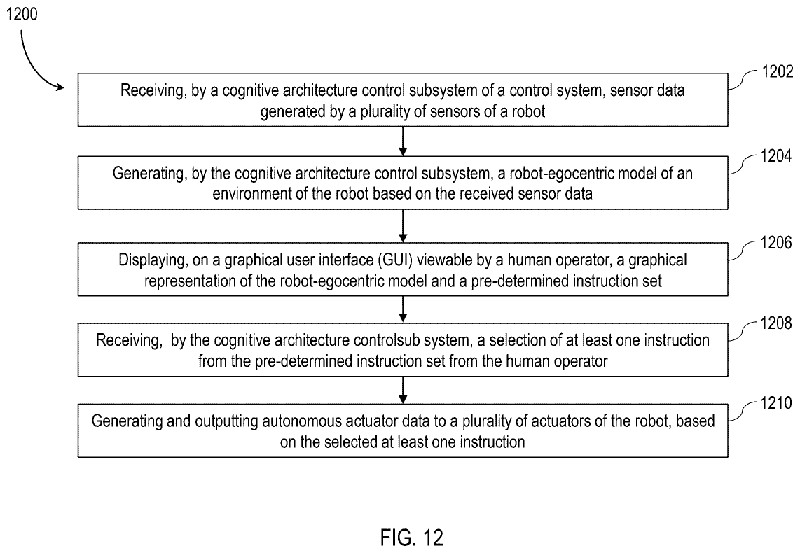

FIG. 12 is a flow diagram of a method for controlling a robot. The method may be performed by any of the systems described above in various embodiments. The control system includes a robot comprising a plurality of sensors and plurality of actuators. The control system also includes a cognitive architecture control subsystem communicatively coupled to the robot. At 1202, the cognitive architecture control system receives sensor data generated by a plurality of sensors of the robot.

As an optional act before 1202, a control-determining unit of the control system may select a robot to control between a physical robot and a simulated robot. The physical robot comprises a plurality of physical sensors generating physical sensor data and a plurality of physical actuators receiving physical actuator data. The physical robot comprises a plurality of simulated sensors generating simulated sensor data and a plurality of simulated actuators receiving simulated actuator data. Each simulated sensor is analogous to a respective physical sensor in a real world physical robot (that may or may not exist). The simulated sensor data is approximately the same as the respective physical sensor data. Each simulated actuator is analogous to a respective physical actuator in a real world physical robot (that may or may not exist). The simulated actuator data is approximately the same as the respective physical actuator data.

The sensor data includes information about the environment of the robot as well as information about the robot itself. For example, the sensor data, both physical sensor data and simulated sensor data, may include at least one of audio sensor data, joint position data, pressure data, force sensitive resistor data, mobile base wheel encoder data, inertial measurement unit data, and visual data.

At 1204, the cognitive architecture control subsystem generates a robot-egocentric model of the environment of the robot based on the received sensor data. The robot-egocentric model represents the environment of the robot as perceived by the robot and enables control of the robot based only on what the robot knows about the environment. The robot-egocentric model includes information about the robot within the environment.

At 1206, the cognitive architecture control subsystem generates a graphical representation of the robot-egocentric model (i.e., an IW model as described above) and displays the graphical representation on a graphical user interface (GUI) viewable by a human operator along with a set of pre-determined instructions.

At 1208, the cognitive architecture control subsystem receives a selection of at least one instruction of the set of pre-determined instructions from the human operator.

The graphical representation of the robot-egocentric model may include detected objects and the human operator may select at least one detected object. The pre-determined set of instructions displayed in the GUI to the human operator may depend on a context of the at least one selected detected object within the robot-egocentric model. The pre-determined instruction set may be displayed as a drop-down menu and when a human operator has selected at least one detected object the contents of the drop-down menu depend on the at least one selected detected object.

The cognitive architecture control subsystem may include a feature extraction module. The sensor data received by the cognitive architecture control subsystem may be received as at least one sensor data stream and the feature extraction module may extract features from the at least one sensor data stream, wherein features are semantically meaningful information, and the features are used to generate the robot-egocentric model.

For example, the features may include locations of detected objects, orientations of detected objects, labels of detected objects, mapping of the environment, text extracted from speech, text extracted from visual feed, facial recognition labels, presence of hand in the scene, joint states for actuators of the robot, faces in a field of view, etc.

The feature extraction module may include a plurality of specialized submodules to each extract a feature from the at least one sensor data stream. The cognitive architecture control subsystem may further include an attention module which is configured to turn on and off the specialized submodules so that the feature extraction module only extracts chosen features at any given time. For example, in FIG. 10A a specialized submodule for extracting features related to food is turned on and a specialized submodule for extracting features related to games or chess is turned off, while in FIG. 10B the opposite is true.

At 1210, the cognitive architecture control subsystem generates autonomous actuator data based on the at least one instruction selected by the human operator and outputs the autonomous actuator data to a plurality of actuators of the robot.

The actuator data may include at least one of audio data, joint position data, impedance data, and mobile base motion data.

The cognitive architecture control subsystem may test the outcome and effects of actuator driven actions based on the at least one instruction within the robot-egocentric model (i.e., the IW model) before sending the actuator data to the actual physical to perform in the physical environment or to the simulated robot to perform in the simulated environment (i.e., the OW model).

The cognitive architecture control subsystem may include a concrete state representation updater which updates a concrete state representation to provide a state representation of a current state of the environment (i.e., physical environment or OW model) as understood by the cognitive architecture control subsystem.

The robots described herein may, in some implementations, employ any of the teachings of U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/253,591, U.S. Provisional Patent Application Ser. No. 63/293,968, U.S. Provisional Patent Application Ser. No. 63/293,973, U.S. Provisional Patent Application Ser. No. 63/278,817, and/or U.S. patent application Ser. No. 17/566,589, each of which is incorporated herein by reference in its entirety.

Throughout this specification and the appended claims the term “communicative” as in “communicative coupling” and in variants such as “communicatively coupled,” is generally used to refer to any engineered arrangement for transferring and/or exchanging information. For example, a communicative coupling may be achieved through a variety of different media and/or forms of communicative pathways, including without limitation: electrically conductive pathways (e.g., electrically conductive wires, electrically conductive traces), magnetic pathways (e.g., magnetic media), wireless signal transfer (e.g., radio frequency antennae), and/or optical pathways (e.g., optical fiber). Exemplary communicative couplings include, but are not limited to: electrical couplings, magnetic couplings, radio frequency couplings, and/or optical couplings.

Throughout this specification and the appended claims, infinitive verb forms are often used. Examples include, without limitation: “to encode,” “to provide,” “to store,” and the like. Unless the specific context requires otherwise, such infinitive verb forms are used in an open, inclusive sense, that is as “to, at least, encode,” “to, at least, provide,” “to, at least, store,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of computer systems and computing environments provided.

This specification provides various implementations and embodiments in the form of block diagrams, schematics, flowcharts, and examples. A person skilled in the art will understand that any function and/or operation within such block diagrams, schematics, flowcharts, or examples can be implemented, individually and/or collectively, by a wide range of hardware, software, and/or firmware. For example, the various embodiments disclosed herein, in whole or in part, can be equivalently implemented in one or more: application-specific integrated circuit(s) (i.e., ASICs); standard integrated circuit(s); computer program(s) executed by any number of computers (e.g., program(s) running on any number of computer systems); program(s) executed by any number of controllers (e.g., microcontrollers); and/or program(s) executed by any number of processors (e.g., microprocessors, central processing units, graphical processing units), as well as in firmware, and in any combination of the foregoing.

Throughout this specification and the appended claims, a “memory” or “storage medium” is a processor-readable medium that is an electronic, magnetic, optical, electromagnetic, infrared, semiconductor, or other physical device or means that contains or stores processor data, data objects, logic, instructions, and/or programs. When data, data objects, logic, instructions, and/or programs are implemented as software and stored in a memory or storage medium, such can be stored in any suitable processor-readable medium for use by any suitable processor-related instruction execution system, apparatus, or device, such as a computer-based system, processor-containing system, or other system that can fetch the data, data objects, logic, instructions, and/or programs from the memory or storage medium and perform various acts or manipulations (i.e., processing steps) thereon and/or in response thereto. Thus, a “non-transitory processor-readable storage medium” can be any element that stores the data, data objects, logic, instructions, and/or programs for use by or in connection with the instruction execution system, apparatus, and/or device. As specific non-limiting examples, the processor-readable medium can be: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and/or any other non-transitory medium.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A control system for controlling operation of a robot in an environment, comprising:
a robot, including:
a plurality of sensors configured to convert information from the environment and the robot into sensor data;
a plurality of actuators configured to cause movement of the robot;
a cognitive architecture control system, communicatively coupled to the robot, configured to control the robot, and to:
receive the sensor data from the plurality of sensors;
generate a robot-egocentric model of the environment from the sensor data; and
output autonomous actuator data to the plurality of actuators of the robot, based on at least one instruction; and
a graphical user interface configured to display a graphical representation of the robot-egocentric model to enable a human operator to select the at least one instruction from a pre-determined instruction set, based on the robot-egocentric model, to control the robot semi-autonomously.

2. The control system of claim 1 wherein the robot is interchangeable between a physical robot in a physical environment and a simulated robot in a simulated environment wherein:
the plurality of sensors of the physical robot comprise a plurality of physical sensors generating physical sensor data from the physical environment, and the plurality of actuators of the physical robot comprises a plurality of physical actuators receiving physical actuator data;
the plurality of sensors of the simulated robot comprises a plurality of simulated sensors generating simulated sensor data from the simulated environment, and the plurality of actuators of the simulated robot comprises a plurality of simulated actuators receiving simulated actuator data.

3. The control system of claim 1 wherein the graphical user interface enables the human operator to select, through the graphical user interface, at least one detected object within the robot-egocentric model, wherein the pre-determined instruction set is based on the selected at least one detected object.

4. The control system of claim 3 wherein the pre-determined instruction set is based on a context of the at least one detected object and the robot-egocentric model.

5. The control system of claim 3 wherein the pre-determined instruction set is displayed as a drop-down menu.

6. The control system of claim 1 wherein the cognitive architecture control system includes a feature extraction module which is configured to receive at least one sensor data stream from the robot and convert the at least one sensor data stream to features, wherein the features are semantically meaningful information, and wherein the features are used to generate the robot-egocentric model.

7. The control system of claim 6 wherein the feature extraction module includes a plurality of specialized submodules to each extract a feature from the at least one sensor data stream.

8. The control system of claim 7 further comprising an attention module which is configured to turn on and off at least one of the specialized submodules.

9. The control system of claim 1 wherein the cognitive architecture control system tests actuator data within the robot-egocentric model to determine the effects of an actuator data driven action before sending the actuator data to the robot.

10. The control system of claim 1 wherein the cognitive architecture control system includes a concrete state representation updater which provides a state representation of a current state of the environment as understood by the cognitive architecture control system.

11. A computer program product comprising a non-transitory processor-readable storage medium storing processor-executable instructions and/or data that, when executed by at least one processor of a robot control system, cause the robot control system to:
receive sensor data from a plurality of sensors of a robot;
generate a robot-egocentric model of an environment of the robot from the sensor data;
display a graphical user interface to a human operator, wherein the graphical user interface includes a graphical representation of the robot-egocentric model and a pre-determined instruction set;
receive a selection of at least one instruction from the pre-determined instruction set from the human operator; and
output autonomous actuator data to a plurality of actuators of the robot, based on the selected at least one instruction.

12. The computer program product of claim 11 wherein the robot is interchangeable between a physical robot in a physical environment and a simulated robot in a simulated environment wherein:
the plurality of sensors of the physical robot comprise a plurality of physical sensors generating physical sensor data from the physical environment, and the plurality of actuators of the physical robot comprises a plurality of physical actuators receiving physical actuator data;
the plurality of sensors of the simulated robot comprises a plurality of simulated sensors generating simulated sensor data from the simulated environment, and the plurality of actuators of the simulated robot comprises a plurality of simulated actuators receiving simulated actuator data; and
wherein, the processor-executable instructions and/or data cause the robot control system to switch between controlling the physical robot and the simulated robot.

13. The computer program product of claim 11 wherein the processor-executable instructions and/or data allow the human operator to select, through the graphical user interface, at least one detected object within the robot-egocentric model, wherein the pre-determined instruction set is based on the selected at least one detected object.

14. The computer program product of claim 13 wherein the pre-determined instruction set is based on a context of the at least one detected object and the robot-egocentric model.

15. The computer program product of claim 13 wherein the pre-determined instruction set is displayed as a drop-down menu.

16. The computer program product of claim 11 wherein the control system includes a feature extraction module and the processor-executable instructions and/or data cause the feature extraction module to receive at least one sensor data stream from the robot and convert the at least one sensor data stream to features, wherein the features are semantically meaningful information, and wherein the features are used to generate the robot-egocentric model.

17. The computer program product of claim 16 wherein the feature extraction module includes a plurality of specialized submodules to each extract a feature from the at least one sensor data stream.

18. The computer program product of claim 17 further comprising an attention module which is configured to turn on and off at least one of the specialized submodules.

19. The computer program product of claim 11 wherein the processor-executable instructions and/or data cause the control system to test actuator data within the robot-egocentric model to determine the effects of an actuator data driven action before sending the actuator data to the robot.

20. The computer program product of claim 11 wherein the control system includes a concrete state representation updater and the processor-executable instructions and/or data cause the concrete state representation update to provide a state representation of a current state of the environment as understood by the cognitive architecture control system.
